(19) United States
(12) Patent Application Publication
(10) Pub. No.: US 2003/0127806 A1
(43) Pub. Date: Jul. 10, 2003

(54) Alignment feature for a fuel cell seal

(76) Inventor: Mark A. Belchuk, Windsor, CA (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/331,090

(22) Filed: Dec. 27, 2002

Related U.S. Application Data
(60) Provisional application No. 60/342,420, filed on Dec. 27, 2001.

(51) Int. Cl. H02G 15/04

(52) U.S. Cl. 277/609

(57) ABSTRACT

Fuel cell gaskets are employed to seal around an individual cell of a fuel cell assembly. The gaskets are made of a flexible material, and each includes at least one alignment feature defined by a partially formed hole creating a flap, with the flap being integral with its gasket. The gasket may be a multi-piece gasket with a carrier material having an elastomeric seal portion secured to it. One or both pieces of the multi-piece gasket may include one or more alignment features.

### CROSS REFERENCE TO RELATED APPLICATIONS

This clams the benefit of United States provisional patent application identified as Application No. 60/342,420, filed Dec. 27, 2001.

### BACKGROUND OF INVENTION

This invention relates in general to static seals and more particularly to a gasket employed for sealing between components in a fuel cell.

A fuel cell is an electrochemical energy converter that includes two electrodes placed on opposite surfaces of an electrolyte. In one form, an ion-conducting polymer electrolyte membrane is disposed between two electrode layers to form a membrane electrode assembly (MEA). The MEA is used to promote a desired electrochemical reaction from two reactants. One reactant, oxygen or air, passes over one electrode while hydrogen, the other reactant, passes over the other electrode. The oxygen and hydrogen combine to produce water, and in the process generate electricity and heat.

An individual cell within a fuel cell assembly includes a MEA placed between a pair of separator plates. The separator plates are typically fluid impermeable and electrically conductive. Fluid flow passages or channels are formed adjacent to each plate surface at an electrode layer to facilitate access of the reactants to the electrodes and the removal of the products of the chemical reaction. In such fuel cells, resilient gaskets or seals are typically provided between the faces of the MEA and the perimeter of each separator plate to prevent leakage of the fluid reactant and product streams. Since the fuel cell operates with oxygen and hydrogen, it is important to provide a seal that not only seals well against hydrogen, oxygen and water, but that will seal well as the temperature changes due to the heat that is given off during fuel cell operation. To assure a good seal, the seals need to be formed accurately as well as aligned properly with the other components. Moreover, the seal needs to be formed and assembled to the other components without waste material or other contaminants interfering with the seal.

Thus, it is desirable to have a gasket of an individual cell of a fuel cell that is relatively easy to align during a molding or assembly operation, while assuring the proper sealing for the finished assembly.

### SUMMARY OF INVENTION

In its embodiments, the present invention contemplates an apparatus for use in an individual cell having a gasket made of a flexible material and including at least one alignment feature defined by a partially formed hole creating a flap, with the flap being integral with the gasket.

The present invention further contemplates an individual cell adapted for use in a fuel cell assembly. The individual cell has a membrane electrode assembly including a first gasket mounted about a first gas diffusion layer and a second gasket mounted about a second gas diffusion layer. The first gasket is made of a flexible material and includes at least one first gasket alignment feature defined by a partially formed hole creating a first gasket flap, with the first gasket flap being integral with the first gasket, and the second gasket is made of a flexible material and includes at least one second gasket alignment feature defined by a partially formed hole creating a second gasket flap, with the second gasket flap being integral with the second gasket. The individual cell also includes a first separator plate mounted to the first gasket, and a second separator plate mounted to the second gasket.

The present invention also contemplates a method of aligning a gasket with another member having an alignment hole, the method comprising the steps of: forming an alignment feature in the gasket defined by a partially formed hole creating an integral flap; and inserting an alignment pin through the alignment feature by moving the flap out of the way; and inserting the alignment pin through the alignment hole in the other member.

An advantage of the present invention is that a gasket component having an integral flap will allow for proper alignment during a subsequent molding and/or assembly process.

Another advantage of the present invention is that the flap will allow for proper alignment of a gasket without generating waste material that might contaminate successive manufacturing operations. Moreover, the flaps will allow for positive alignment of the gasket without requiring the use of additional material to form an alignment feature.

### BRIEF DESCRIPTION OF DRAWINGS

FIG. 1 is an schematic, exploded, perspective view of an individual cell of a fuel cell assembly in accordance with an embodiment of the invention;

FIG. 2 is a plan view of a gasket and gas diffusion layer in accordance with an embodiment of the present invention;

FIG. 3 is a partial, sectional view of a gasket mounted on a fixture, in accordance with the present invention; and

FIG. 4 is a partial, sectional view of a gasket assembly in accordance with a second embodiment of the present invention.

### DETAILED DESCRIPTION

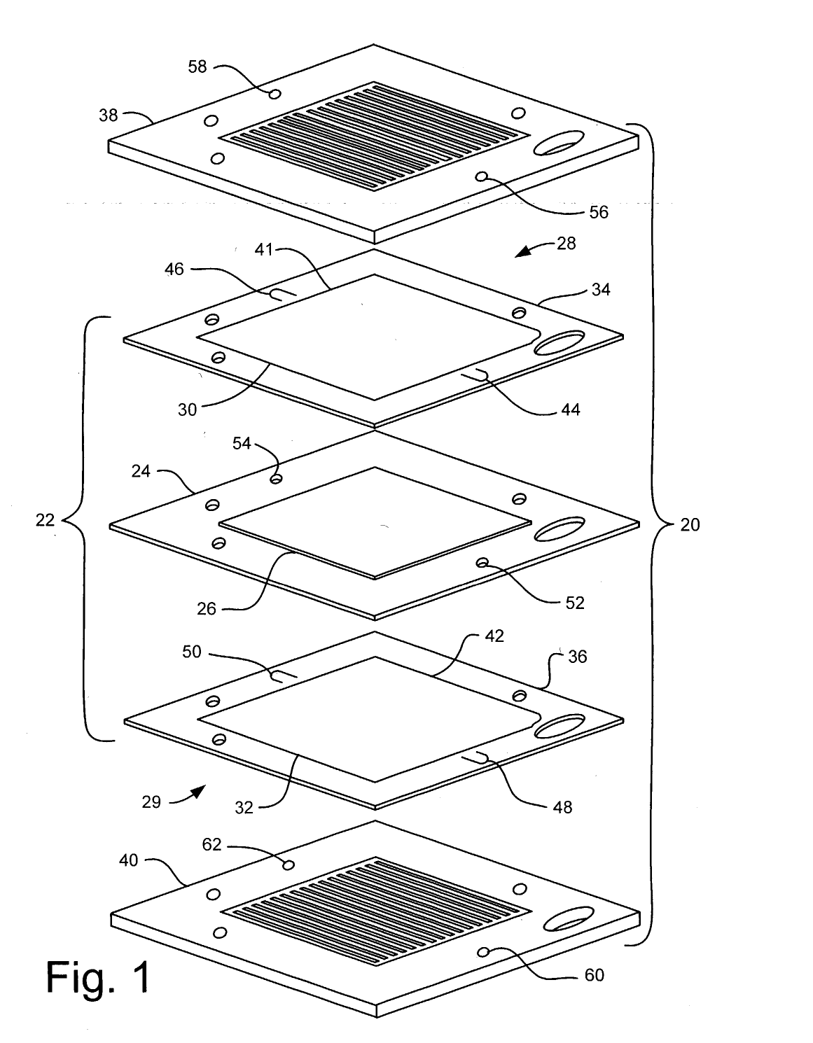

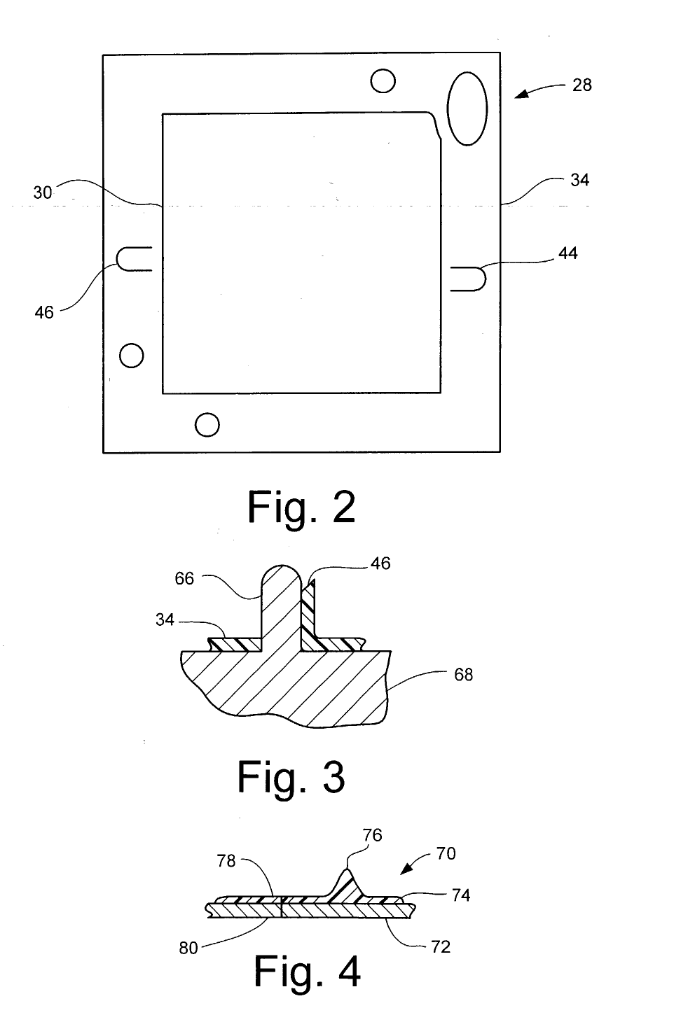

FIGS. 1-2 illustrate an individual cell 20 for use in a fuel cell assembly. The individual cell 20 includes a gasket unitized membrane electrode assembly (MEA) 22. The MEA 22 is made up of a membrane 24, with a layer of catalyst material 26 on both sides of the membrane 24. The MEA 22 also includes a first gas diffusion layer (GDL) 30 and second GDL 32 on either side of the layers of catalyst material 26, and a first gasket 34 and a second gasket 36, secured around the perimeters 41, 42 of the first GDL 30 and the second GDL 32, respectively. Preferably, the gaskets 34, 36 are secured to the GDLs 30, 32 by adhesive, although other means of securing may be used if so desired, such as molding each gasket to its GDL. Each GDL 30, 32 and its corresponding gasket 34, 36 forms a unitized seal-diffusion assembly 28, 29, respectively. The unitized seal-diffusion assemblies 28, 29 are preferably secured to the membrane 24 with an adhesive, although other means of securing may also be employed. A first separator plate 38 mounts against the first gasket 34 and the first GDL 30, and a second separator plate 40 mounts against the second gasket 36 and the second GDL 32, in order to form the individual cell 20.

The membrane 24 is preferably an ion-conducting, polymer, electrolyte membrane, as generally employed in this type of fuel cell application. The catalyst material 26 is preferably platinum or other suitable catalyst material for a typical polymer electrode membrane type of fuel cell application. The first and second GDLs 30, 32 are preferably a carbonized fiber, or may be another suitable gas permeable material for use as an electrode in a fuel cell. The MEA 22 can include a catalyzed membrane with GDLs assembled thereto, or a membrane assembled between two catalyzed GDLs, each of which is known to those skilled in the art. The first and second separator plates 38, 40 are generally rectangular in shape, although other shapes can also be employed if so desired. The plates 38, 40 have outer surfaces that are made to mate with adjoining individual cells in order to make up a completed fuel cell assembly. Since the relative thicknesses of the various components are very thin, they are only depicted schematically in the figures in order to aid in describing the invention. The actual thicknesses of the components may vary according to the particular application of the fuel cell and are known to those skilled in the art.

The first gasket 34 includes a first alignment feature 44 and a second alignment feature 46, and the second gasket 36 includes a first alignment feature 48 and a second alignment feature 50. Each alignment feature is a partially cut hole through the gaskets 34, 36, forming a flap 44, 46. While two flaps are shown per unitized seal-diffusion assembly 28, 29, a different number of flaps can be employed, as desired, in order to assure the proper alignment of the assembly during fabrication and/or assembly processes. The flaps are movable, yet are retained by the gaskets. This allows them to be pulled aside when needed for alignment purposes, while not falling out and potentially becoming a contaminant in the molding or assembly equipment.

The membrane 24 may have first and second holes 52, 54, the first separator plate 38 may have first and second holes 56, 58, and/or the second separator plate 40 may have first and second holes 60, 62 that are located to align with the first flaps 44, 48 and second flaps 46, 50 of the first and second gaskets 34, 36. For example, the first flaps 44, 48 can be aligned with the first hole 52 in the membrane 24, while the second flaps 46, 50 are aligned with the second hole 54 in the membrane 24—after an adhesive has been applied between these layers. The components can then be brought together until the adhesive cures in order to form the gasket unitized MEA 22. The adhesive is preferably a pressure sensitive adhesive, although other means of securing the components together may also be employed. Positive alignment of the components may be assured by inserting alignment pins, or other members, through the holes and flaps.

FIG. 3 illustrates a portion of the gasket 34 while it is mounted on an alignment pin 66 of an installation fixture 68 (or a mold if the alignment pin 66 is being employed for a molding process). The flap 46 moves aside, allowing the alignment pin 66 to slide through and positively retain the gasket 34. After the pin 66 is removed, the flap 46 may then move back into its original position.

FIG. 4 illustrates a second embodiment of the present invention where the gasket 70 is formed of multiple components. A first component is a gasket carrier 72, which has an elastomeric seal portion 74 molded to it. The carrier 72 is preferably a thin, flexible member that has a preferred thickness of less than 1.0 millimeter and is preferably made of a polymeric material. The elastomeric seal portion 74 is preferably made of an elastomeric material with good sealing properties, such as, for example, rubber. The seal portion 74 may be molded to either side of the carrier 72, as is desired for the particular fuel cell application. Also, the seal portion 74 may include a sealing bead 76 protruding therefrom, if so desired, as is known in the art. The advantage of the multi-component gasket 70 is that the carrier 72, while flexible, can aid in the handling of the seal portion 74 by improving the retention of two dimensions of the gasket 70 better than the elastomeric portion 74 alone would.

The elastomeric seal portion 74 includes a flap 78 that aligns with a flap 80 in the carrier 72. These flaps 78, 80 allow for the gasket 70 to be properly aligned while being assembled to other components of the cell. As with the first embodiment, this can be any number of flaps located around the gasket 70, as is desired to assure proper alignment.

Alternatively, the gasket carrier may include one or more flaps prior to the forming of the elastomeric portion. These flaps are then employed to align the gasket carrier 72 with a mold while the elastomeric seal portion 78 is molded to it. The elastomeric seal portion 78 may also be molded with one or more flaps (or they may be formed after the molding operation), if so desired. The flaps 78, 80 can then be employed during the individual cell assembly process, as discussed above, in order to assure proper alignment. Thus, flaps can be employed both to assure proper alignment during a molding operation and during an assembly process.

While certain embodiments of the present invention have been described in detail, those familiar with the art to which this invention relates will recognize various alternative designs and embodiments for practicing the invention as defined by the following claims.

What is claimed is:

1. An apparatus for use in an individual cell comprising:
a gasket made of a flexible material and including at least one alignment feature defined by a partially formed hole creating a flap, with the flap being integral with the gasket.

2. The apparatus of claim 1 further including a gas diffusion layer having a perimeter, and with the gasket shaped to surround the perimeter of the gas diffusion layer.

3. The apparatus of claim 2 wherein the gasket includes a carrier layer and an elastomeric seal layer mounted thereto, with the carrier layer including the at least one alignment feature.

4. The apparatus of claim 3 wherein the elastomeric seal layer also includes at least one alignment feature.

5. The apparatus of claim 2 wherein the carrier is made of a polymeric material and the elastomeric seal layer is made of rubber.

6. The apparatus of claim 2 wherein the at least one alignment feature is two alignment features.

7. The apparatus of claim 1 wherein the gasket includes a carrier layer and an elastomeric seal layer mounted thereto, with the carrier layer including the at least one alignment feature.

8. The apparatus of claim 7 wherein the elastomeric seal layer also includes at least one alignment feature.

9. An individual cell adapted for use in a fuel cell assembly comprising:
a membrane electrode assembly including a first gasket mounted about a first gas diffusion layer and a second gasket mounted about a second gas diffusion layer;
wherein the first gasket is made of a flexible material and includes at least one first gasket alignment feature defined by a partially formed hole creating a first gasket flap, with the first gasket flap being integral with the first gasket, and the second gasket is made of a flexible material and includes at least one second gasket alignment feature defined by a partially formed hole creating a second gasket flap, with the second gasket flap being integral with the second gasket;
a first separator plate mounted to the first gasket; and
a second separator plate mounted to the second gasket.

10. The individual cell of claim 9 wherein the first gasket includes a carrier layer and an elastomeric seal layer mounted thereto, with the carrier layer including the at least one first gasket alignment feature.

11. The individual cell of claim 10 wherein the second gasket includes a carrier layer and an elastomeric seal layer mounted thereto, with the carrier layer including the at least one second gasket alignment feature.

12. The individual cell of claim 11 wherein the elastomeric seal layer of the second gasket also includes at least one alignment feature.

13. The individual cell of claim 10 wherein the elastomeric seal layer of the first gasket also includes at least one alignment feature.

14. The individual cell of claim 9 wherein the membrane electrode assembly includes a membrane having at least one hole alignable with the at least one first gasket alignment feature and the at least one second gasket alignment feature.

15. A method of aligning a gasket with another member having an alignment hole, the method comprising the steps of:
forming an alignment feature in the gasket defined by a partially formed hole creating an integral flap; and
inserting an alignment pin through the alignment feature by moving the flap out of the way; and
inserting the alignment pin through the alignment hole in the other member.

16. The method of claim 15 wherein the other member is further defined as a membrane in a membrane electrode assembly.

17. The method of claim 15 wherein the step of forming an alignment feature is further defined by forming a gasket of a carrier layer with an elastomeric layer secured thereto, and forming the alignment feature in the carrier layer.

18. The method of claim 15 further including the step of securing the gasket about a perimeter of a gas diffusion layer.

19. The method of claim 17 wherein the step of forming an alignment feature includes forming the carrier of a polymeric material and forming the elastomeric layer of rubber.

20. The method of claim 15 further including the steps of forming a second alignment feature in the gasket defined by a partially formed hole creating a second integral flap; and inserting a second alignment pin through the second alignment feature by moving the second flap out of the way
